(19) United States
(12) Patent Application Publication
(10) Pub. No.: US 2025/0379389 A1
(43) Pub. Date: Dec. 11, 2025

(54) CONNECTOR ASSEMBLY, FIRST CONNECTOR, AND SECOND CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Seido NISHIJIMA, Mie (JP); Akio KIMURA, Mie (JP)

(21) Appl. No.: 18/878,647

(22) PCT Filed: Jun. 14, 2023
(86) PCT No.: PCT/JP2023/022003

§ 371 Date: Dec. 24, 2024

(30) Foreign Application Priority Data
Jun. 28, 2022 (JP) 2022-103639

(51) Int. Cl. H01R 13/502; H01R 13/621; H01R 13/6581

(52) U.S. Cl. CPC H01R 13/502; H01R 13/621; H01R 13/6581

(57) ABSTRACT

A connector assembly includes a first connector and a second connector. The first connector includes a first terminal fitting projecting outward from a casing made of metal and a receptacle made of metal and projecting from the casing while surrounding the first terminal fitting. The second connector includes a second terminal fitting to be connected to the first terminal fitting, an insulating housing for accommodating the second terminal fitting and a flat plate portion made of metal and fixedly disposed on an outer surface side of the housing. In a connected state of the first and second connectors, the housing of the second connector is accommodated and arranged in the receptacle of the first connector, a contact portion of the flat plate portion is placed on and connected to a projecting end surface of the receptacle.

### TECHNICAL FIELD

The present disclosure relates to a connector assembly and a first connector and a second connector constituting the connector assembly.

### BACKGROUND

Conventionally, a connector provided with a shielding function has been used for the purpose of suppressing noise in power transmission between in-vehicle components. For example, Patent Document 1 proposes a structure for surrounding an insulating housing for accommodating a terminal fitting connected to a coated wire end by a shield shell made of metal in a connector provided on the end of the wire.

### PRIOR ART DOCUMENT

### Patent Document

Patent Document 1: JP 2018-181831 A

### SUMMARY OF THE INVENTION

### Problems to be Solved

However, in the structure of Patent Document 1, the shield shell made of metal for surrounding the insulating housing needs to be manufactured by die casting or the like and a problem that manufacturing cost is high has been inherent. Further, since the shield shell needs to surround a wide range of the housing to ensure a shielding property of the connector, there have been cases where enlargement is unavoidable and a request for miniaturization cannot be met.

Accordingly, a connector assembly and a first connector and a second connector used in the connector assembly are disclosed which can achieve a manufacturing cost reduction and miniaturization by structure simplification.

### Means to Solve the Problem

A connector assembly of the present disclosure is provided with a first connector and a second connector to be connected to the first connector, the first connector including a first terminal fitting projecting outward from a casing made of metal and a receptacle made of metal and projecting outward from the casing while surrounding the first terminal fitting, the second connector including a second terminal fitting to be connected to an end of a coated wire and connected to the first terminal fitting, an insulating housing for accommodating the second terminal fitting and a flat plate portion made of metal and fixedly disposed on an outer surface side of the housing, and in a connected state of the first and second connectors, the housing of the second connector being accommodated and arranged in the receptacle of the first connector, a contact portion of the flat plate portion being placed on and connected to a projecting end surface of the receptacle and a projecting side opening of the receptacle being covered by the flat plate portion.

A first connector of the present disclosure is to be used in the connector assembly of the present disclosure, the first connector being connected to the second connector.

A second connector of the present disclosure is to be used in the connector assembly of the present disclosure, the second connector being connected to the first connector.

### Effect of the Invention

According to the present disclosure, it is possible to provide a connector assembly and a first connector and a second connector used in the connector assembly which can achieve a manufacturing cost reduction and miniaturization by structure simplification.

### BRIEF DESCRIPTION OF THE DRAWINGS

FIG. 1 is a perspective view showing a connector assembly according to one embodiment in a state where a first connector and a second connector are connected.

FIG. 2 is a plan view of the connector assembly shown in FIG. 1.

FIG. 3 is a longitudinal section enlargedly showing an essential part of a cross-section along III-III in FIG. 2.

FIG. 4 is a transverse section enlargedly showing an essential part of a cross-section along IV-IV in FIG. 3.

FIG. 5 is a longitudinal section enlargedly showing an essential part of a cross-section along V-V in FIG. 3.

FIG. 6 is a transverse section enlargedly showing an essential part of a cross-section along VI-VI in FIG. 2.

FIG. 7 is a transverse section enlargedly showing an essential part of a cross-section along VII-VII in FIG. 2.

FIG. 8 is a perspective view of the connector assembly shown in FIG. 1 showing a state where the first and second connectors are separated.

FIG. 9 is a perspective view of the first connector constituting the connector assembly shown in FIG. 1.

FIG. 10 is an exploded perspective view of the first connector shown in FIG. 9.

FIG. 11 is a bottom view of the second connector constituting the connector assembly shown in FIG. 1.

FIG. 12 is an exploded perspective view of a second connector shown in FIG. 11.

FIG. 13 is a perspective view of a second connector housing body constituting the second connector shown in FIG. 11 when viewed from a bottom surface side.

### DETAILED DESCRIPTION TO EXECUTE THE INVENTION

### Description of Embodiments of Present Disclosure

First, embodiments of the present disclosure are listed and described.

(1) The connector assembly of the present disclosure is provided with a first connector and a second connector to be connected to the first connector, the first connector including a first terminal fitting projecting outward from a casing made of metal and a receptacle made of metal and projecting outward from the casing while surrounding the first terminal fitting, the second connector including a second terminal fitting to be connected to an end of a coated wire and connected to the first terminal fitting, an insulating housing for accommodating the second terminal fitting and a flat plate portion made of metal and fixedly disposed on an outer surface side of the housing, and in a connected state of the first and second connectors, the housing of the second connector being accommodated and arranged in the receptacle of the first connector, a contact portion of the flat plate portion being placed on and connected to a projecting end surface of the receptacle and a projecting side opening of the receptacle being covered by the flat plate portion.

According to the connector assembly of the present disclosure, the first connector is provided with the receptacle made of metal, the second connector is provided with the flat plate portion made of metal, and the first and second connectors connected to each other can be surrounded by a metal member and the shielding performance of the connector assembly can be ensure by assembling the receptacle and the flat plate portion. Since the receptacle and the flat plate portion can be both formed by press working, a shield shell required in a conventional structure to surround a housing needs not be manufacturing by die casting. In this way, the structure of the connector assembly can be simplified, whereby a manufacturing cost reduction and miniaturization can be achieved.

Note that the receptacle may be integrally provided to the casing of a device or the like, on which the first connector is provided, or a separately manufactured receptacle may be fixed later by welding or the like. Further, the flat plate portion may be fixedly disposed on the outer surface side of the housing by insert-molding the housing of the second connector with the flat plate portion as an insert or may be fixedly provided by being fixed to the outer surface of the housing by an arbitrary direction such as welding. Further, to advantageously ensure the insulating property of the second connector, the flat plate portion is preferably covered by the housing and the contact portion is preferably exposed from the housing.

(2) Preferably, the second connector further includes a shield bracket to be connected to a shield member for covering the coated wire extending from a wire pull-out opening provided in the housing, thereby surrounding the wire pull-out opening, the shield bracket is assembled with and connected to the flat plate portion, the receptacle of the first connector includes a lateral opening, the coated wire being pulled out through the lateral opening, and the lateral opening of the receptacle is covered by the shield bracket in the connected state of the first and second connectors.

In the second connector, if the coated wire connected to the second terminal fitting is a non-shielded wire, it is necessary to ensure a shielding effect by covering the coated wire by the shield member such as a braided wire and grounding the shield member. Accordingly, the shield member is connected to the shield bracket surrounding the wire pull-out opening, and the shield bracket is connected to the flat plate portion. Since the flat plate portion is connected to the receptacle made of metal and projecting on the metal-made casing of an in-vehicle device or the like, the shielding effect in the case of adopting the non-shielded wire can be advantageously ensured. As a result, effects of a cost reduction and miniaturization of the connector assembly can be advantageously enjoyed even in the case of the non-shielded wire. Particularly, the shield bracket connected to the shield member for covering the coated wire also fulfills a function of covering the lateral opening of the receptacle, and the shielding performance of the connector assembly in the case of using the non-shielded wire can be ensured with a small number of components.

(3) Preferably, at least one of the contact portion of the flat plate portion and the projecting end surface of the receptacle is provided with a contact point portion projecting toward the other in an overlapping direction of the flat plate portion on the projecting end surface. Since at least one of the contact portion and the projecting end surface is provided with the contact point portion projecting toward the other, a contact pressure of the contact point portion between contact surfaces of the contact portion and the projecting end surface can be enhanced and the contact point portion can be made clear. As a result, the shielding performance of the connector assembly can be advantageously maintained and controlled.

(4) Preferably, in (3) described above, the first and second connectors are fastened to each other by a fastening bolt extending in a projecting direction of the receptacle, the fastening bolt is arranged on the lateral opening side of the receptacle, and a plurality of the contact point portions are distributed and arranged on both sides across the fastening bolt in a direction orthogonal to a facing direction of the lateral opening of the receptacle and a facing wall facing the lateral opening on the contact portion on the facing wall side.

A contact pressure of the contact point portion can be ensured, utilizing an axial force of the fastening bolt for holding the first and second connectors in the connected state. Moreover, since the plurality of contact point portions are distributed and arranged on the both sides across the fastening bolt in the direction orthogonal to the facing direction of the lateral opening and the facing wall on the projecting end surface on the facing wall side separated from the fastening bolt, regions to which a load of the fastening bolt is applied can be distributed in a well-balanced manner around the receptacle and an assembled state of the receptacle and the flat plate portion can be stabilized and the shielding performance thereby can be also stabilized.

(5) In any one of (2) to (4) described above, the receptacle includes a pair of guide wall portions respectively extending in a pull-out direction of the coated wire from a pair of peripheral wall end surfaces defining the lateral opening, the flat plate portion includes a pair of fastening pieces projecting toward the receptacle, the shield bracket being bolted to the pair of fastening pieces, and the pair of the fastening pieces are respectively arranged on outer sides in a facing direction of the guide wall portions across the pair of guide wall portions, and arranged inwardly of outermost parts of the receptacle in the facing direction of the guide wall portions.

By providing the pair of guide wall portions on the lateral opening of the receptacle, an extension direction of the coated wire can be guided and stabilized. Further, the pair of fastening pieces of the flat plate portion, to which the shield bracket is bolted, can be accommodated in spaces between the outermost parts of the receptacle and the guide wall portions in the facing direction of the pair of guide wall portions, and a risk of interference with other members can be reduced by suppressing outward projection of the pair of fastening pieces.

(6) Preferably, in (5) described above, bent portions respectively bent outward in the facing direction of the guide wall portions are provided on end parts in an extension direction of the pair of guide wall portions. The guide wall portions can be reinforced by the bent portions, and the formation of a gap between the shield bracket and the lateral opening can be advantageously suppressed by the bent portions.

(7) The first connector of the present disclosure is to be used in the connector assembly of any one of (1) to (6) described above, and connected to the second connector.

According to the present disclosure, it is possible to provide the first connector constituting the connector assembly of any one of (1) to (6) described above by being connected to the second connector.

(8) The second connector of the present disclosure is to be used in the connector assembly of any one of (1) to (6) described above, and connected to the first connector.

According to the present disclosure, it is possible to provide the second connector constituting the connector assembly of any one of (1) to (6) described above by being connected to the first connector.

### Details of Embodiment of Present Disclosure

Specific examples of a connector assembly of the present disclosure and a first connector and a second connector constituting the connector assembly are described below with reference to the drawings. Note that the present disclosure is not limited to these illustrations, but is represented by claims and intended to include all changes in the scope of claims and in the meaning and scope of equivalents.

### Embodiment

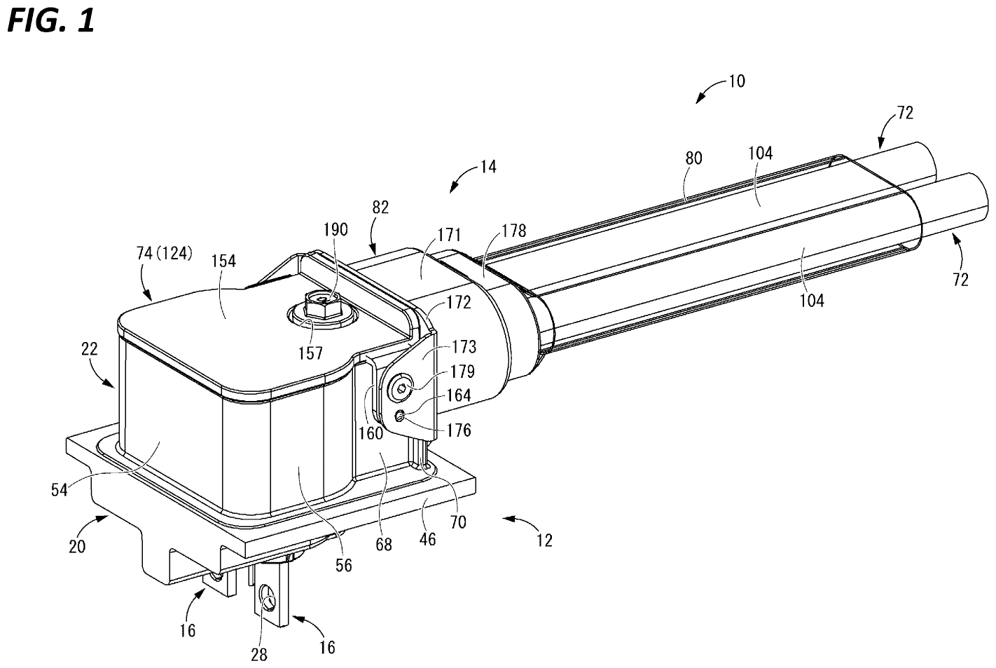

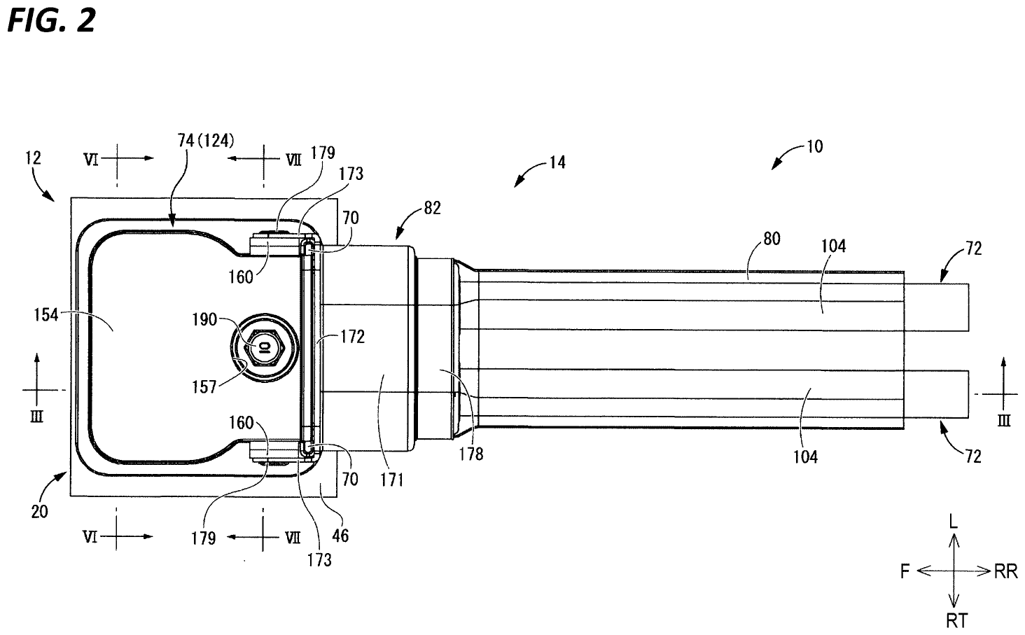

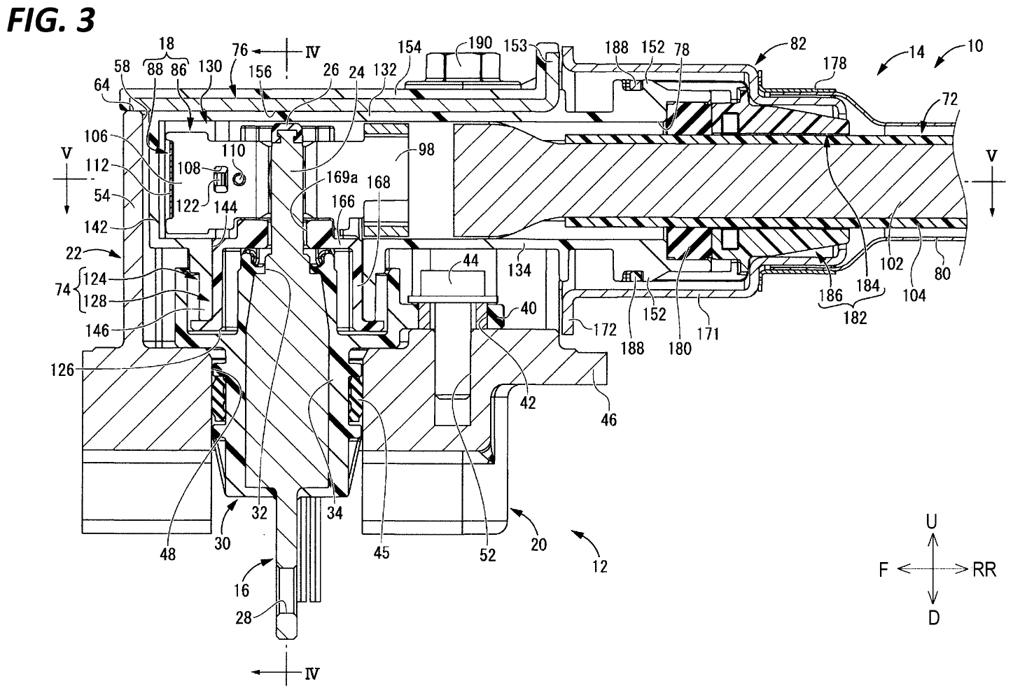

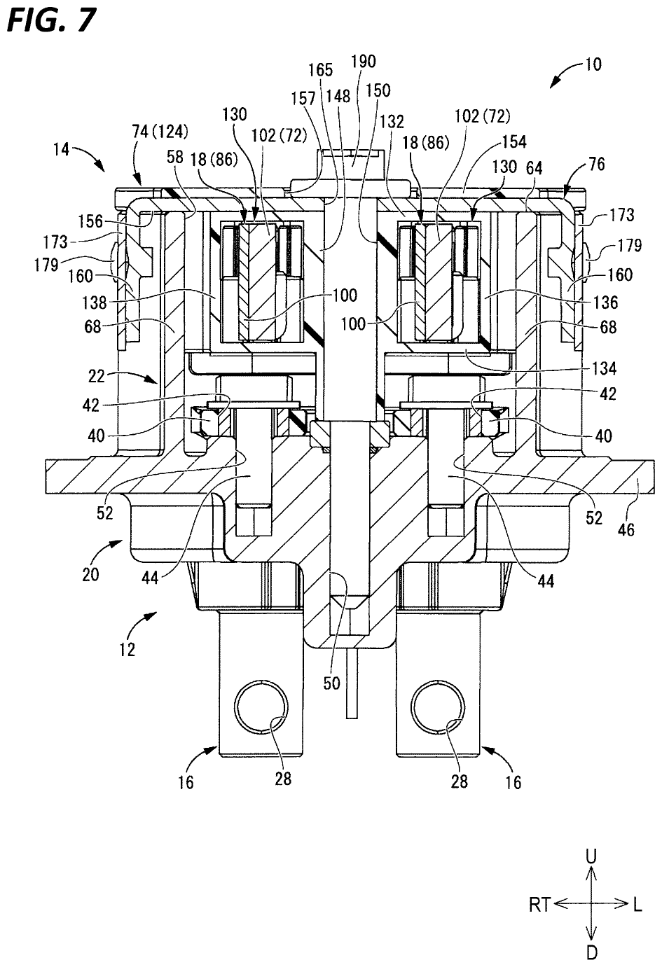

Hereinafter, a connector assembly 10 of one embodiment of the present disclosure is described with reference to FIGS. 1 to 13. The connector assembly 10 includes a first connector 12 and a second connector 14 to be connected to the first connector 12. By connecting the first and second connectors 12, 14, first terminal fittings 16 in the first connector 12 and second terminal fittings 18 in the second connector 14 are brought into an electrically conductive state. Note that the connector assembly 10 can be arranged in an arbitrary orientation, but upper and lower sides in FIG. 3 are referred to as upper and lower sides, left and right sides in FIG. 2 are referred to as front and rear sides, and upper and lower sides in FIG. 2 are referred to as left and right sides below. Further, for a plurality of identical members, only some members may be denoted by a reference sign and the other members may not be denoted by the reference sign.

### (First Connector 12)

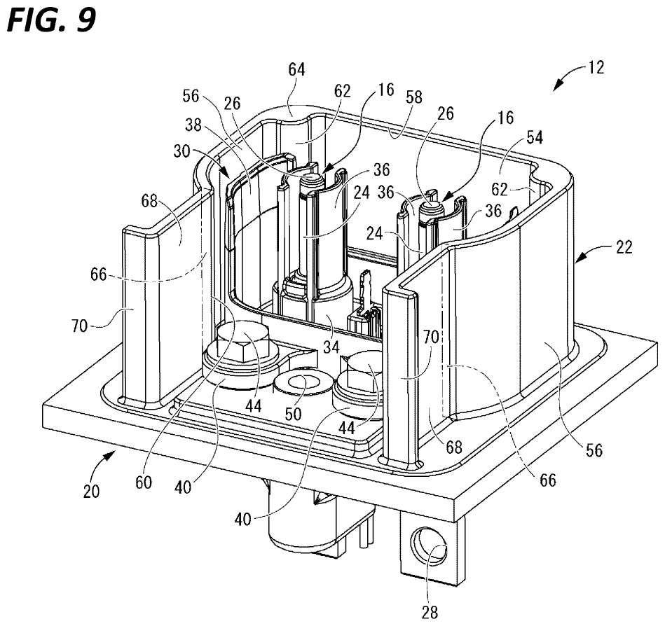

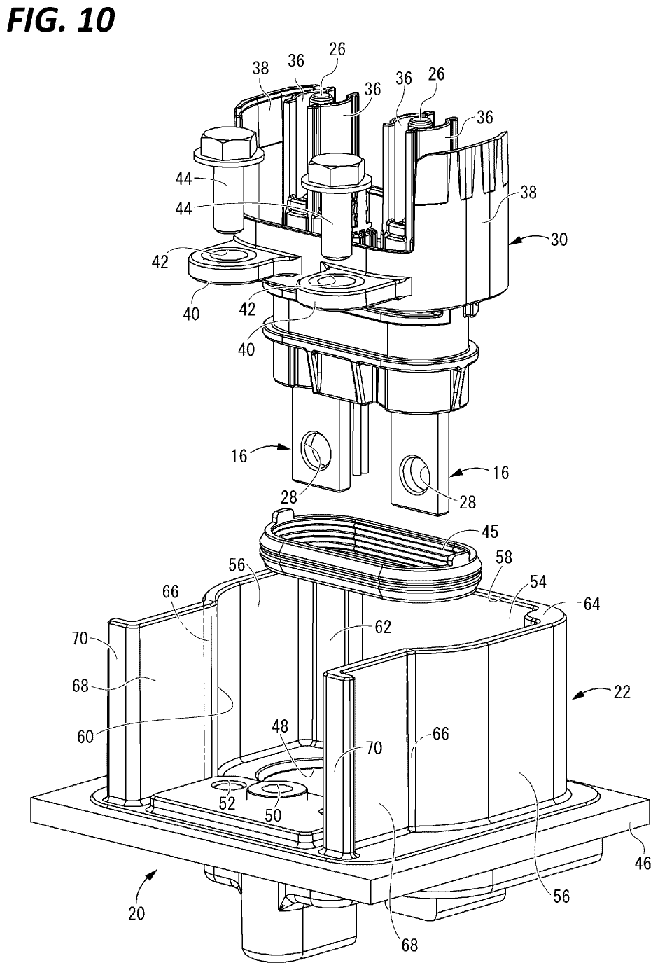

As shown in FIGS. 9 and 10, the first connector 12 is provided with the first terminal fittings 16 projecting outward from a casing 20 made of metal and a receptacle 22 made of metal and projecting outward from the enclosure 20 while surrounding the first terminal fittings 16. That is, the first terminal fittings 16 and the receptacle 22 project in the same direction with respect to the casing 20. In this embodiment, both the first terminal fittings 16 and the receptacle 22 project upward with respect to the casing 20. Further, the first connector 12 is provided with a pair of the first terminal fittings 16, 16, and the pair of first terminal fittings 16, 16 are arranged apart from each other in a lateral direction inside the receptacle 22.

In this embodiment, each first terminal fitting 16 is a pin terminal and includes a columnar connecting portion 24. Further, in the columnar connecting portion 24 of each first terminal fitting 16, a resin cap 26 is provided on a tip side in a press-fit direction (direction from bottom to top as described later) into a later-described tubular connecting portion 84 of the second terminal fitting 18. In this embodiment, a bolt insertion hole 28 is provided in a base end part (lower end part) of each first terminal fitting 16, and each first terminal fitting 16 is fixed to a terminal portion of an unillustrated device or the like by a bolt inserted through the bolt insertion hole 28. Note that the bolt insertion hole 28 in each first terminal fitting 16 may not be provided, and each first terminal fitting may be fixed to an unillustrated device or the like by having the base end of each first terminal fitting crimped or fixed to a wire of the device or the like.

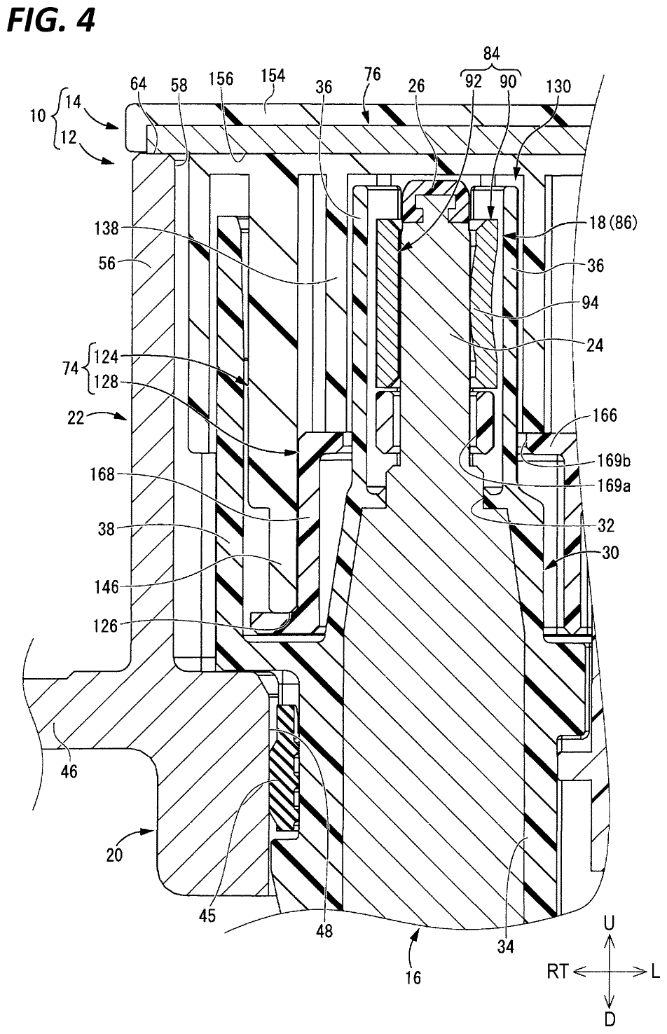

Each of these first terminal fittings 16 is fixedly held in a first connector housing 30. As also shown in FIGS. 4, 9, 10 and the like, the first connector housing 30 is provided with substantially tubular peripheral wall portions 34 each including a through hole 32, through which each first terminal fitting 16 is inserted, in an upper end part, and a pair of the peripheral wall portions 34, 34 are provided apart from each other in the lateral direction. Further, curved plate portions 36 projecting upward and having a predetermined length (dimension in a vertical direction) are provided on the upper end surface of each peripheral wall portion 34. A pair of the curved plate portions 36, 36 are provided on each peripheral wall portion 34, and this pair of curved plate portions 36, 36 are facing away from each other in the lateral direction. Each curved plate portion 36 is curved along a circumferential direction of each peripheral wall portion 34 and has a predetermined dimension in the circumferential direction.

The first connector housing 30 and each first terminal fitting 16 are fixed with each first terminal fitting 16 inserted and arranged in each peripheral wall portion 34 and each columnar connecting portion 24 projecting upward through each through hole 32. Note that a method for fixing the first connector housing 30 and each first terminal fitting 16 is not limited, and these may be fixed by press-fitting, concave-convex locking, adhesion, welding or the like. In this embodiment, the first connector housing 30 is formed as an integrally molded product provided with each terminal fittings 16 by molding with each first terminal fittings 16 inserted in a molding cavity during the molding of the first connector housing 30. With each first terminal fitting 16 fixed to the first connector housing 30, the columnar connecting portion 24 is located on an inner peripheral side of each curved plate portion 36 while being separated from the curved plate portion 36 by a predetermined radial distance, and the columnar connecting portion 24 is covered over an entire length in a length direction by each curved plate portion 36.

Further, the first connector housing 30 is integrally provided with a pair of outer wall portions 38, 38 located laterally outward of the respective peripheral wall portions 34 and projecting upward. This pair of outer wall portions 38, 38 are respectively located laterally outward of the outer curved plate portions 36 of the pairs of curved plate portions 36, 36 while being separated by a predetermined separation distance. Further, as also shown in FIGS. 3, 9 and 10, the first connector housing 30 is integrally provided with leg portions 40 projecting rearward, and the leg portion 40 is formed with a bolt insertion hole 42 penetrating in a vertical direction.

In this embodiment, a pair of the leg portions 40, 40 are provided apart from each other in the lateral direction, and the first connector housing 30 having each first terminal fitting 16 fixed thereto is fixed to the casing 20 by bolts 44 inserted through the bolt insertion holes 42 of these leg portions 40 as described later. With the first connector housing 30 fixed to the casing 20, the columnar connecting portion 24 of each first terminal fitting 16 projects upward from the peripheral wall portion 34 and is exposed to an outside space, and the respective curved plate portions 36 covering each columnar connecting portion 24 from an outer peripheral side and the respective outer wall portions 38 covering the respective curved plate portions 36 from lateral outer sides are located inside the receptacle 22. Further, an annular waterproof rubber 45 is externally fit and mounted on a part to be inserted into an insertion hole 48 of the casing 20 to be described later, on the outer peripheral surface of the first connector housing 30.

### (Casing 20)

The casing 20 is provided with a rectangular plate portion 46 having a rectangular shape in a plan view, and the insertion hole 48, into which the first connector housing 30 is inserted, is formed in a front part of the rectangular plate portion 46. The insertion hole 48 has a substantially elliptical shape with a dimension in the lateral direction larger than a dimension in a front-rear direction. Further, a bolt fastening hole 50, to which a fastening bolt 190 to be described later is fastened, and bolt fastening holes 52, to which the aforementioned bolts 44 are fastened, are provided in a part behind the insertion hole 48 in the rectangular plate portion 46. In this embodiment, a pair of the bolt fastening holes 52, 52, to which the respective bolts 44 are fastened, are separated from each other in the lateral direction, and the bolt fastening hole 50, to which the fastening bolt 190 is fastened, is provided between the pair of bolt fastening holes 52, 52 in the lateral direction.

### (Receptacle 22)

As described above, the first connector 12 is provided with the receptacle 22 projecting upward from the casing 20 and, in this embodiment, the receptacle 22 is integrally formed to the casing 20. As also shown in FIGS. 9 and 10, the receptacle 22 has a predetermined dimension in the vertical direction and is provided to surround the insertion hole 48 in the casing 20 on three sides. That is, the receptacle 22 is provided with a front wall portion 54 located in front of the insertion hole 48 and both side wall portions 56, 56 located on both left and right sides of the insertion hole 48. In other words, the insertion hole 48 is provided inside a region surrounded by the front wall portion 54 and the both side wall portions 56, 56. In this way, the receptacle 22 is provided with an upper opening 58, which is a projecting side opening, and a rear opening 60, which is a lateral opening.

Each of the front wall portion 54 and the both side wall portions 56, 56 is in the form of a rectangular plate having a substantially constant thickness, and the front wall portion 54 and the both side wall portions 56, 56 are connected in a front end part of the receptacle 22. In connected parts of the front wall portion 54 and the both side wall portions 56, 56, thick portions 62 thicker than other parts are provided. As a result, an upper end surface 64, which is the projecting end surface of the receptacle 22, has a larger width in the connected parts of the front wall portion 54 and the both side wall portions 56, 56 where the thick portions 62 are formed than in the other parts (dimension in the front-rear direction of the front wall portion 54 and dimension in the lateral direction of each side wall portion 56).

Further, in the receptacle 22, rear end parts of the both side wall portions 56, 56 facing each other in the lateral direction come closer to each other to gradually reduce a facing distance toward a rear side. In this way, a rear end surface 66 (shown by two-dot chain line in FIGS. 9 and 10), which is an end surface on a side opposite to the side connected to the front wall portion 54 in each side wall portion 56 is located laterally inward of an intermediate part in the front-rear direction of each side wall portion 56. That is, the rear opening 60, which is a lateral opening of the receptacle 22, is defined by the both rear end surfaces 66, 66, and a pair of peripheral wall end surfaces defining the lateral opening (rear opening 60) are constituted by the respective rear end surfaces 66.

Further, the receptacle 22 includes a pair of guide wall portions 68 extending in a direction from front to rear, which is a pull-out direction of coated wires 72 to be described later, from these rear end surfaces 66. The respective guide wall portions 68 are substantially in the form of rectangular plates, have a predetermined dimension in the front-rear direction and are facing each other in the lateral direction. Further, as described above, each guide wall portion 68 is located laterally inward of the intermediate part in the front-rear direction of each side wall portion 56. The respective bolt fastening holes 50, 52 located behind the insertion hole 48 are located between these guide wall portions 68 facing each other in the lateral direction. Therefore, the bolt fastening hole 50 and the later-described fastening bolt 190 to be fastened to the bolt fastening hole 50 are arranged on the side of the rear opening 60 in the receptacle 22. Note that bent portions 70 bent laterally outward in a facing direction of the respective guide wall portions 68 are provided on rear end parts, which are end parts in an extension direction, of the respective guide wall portions 68.

### (Second Connector 14)

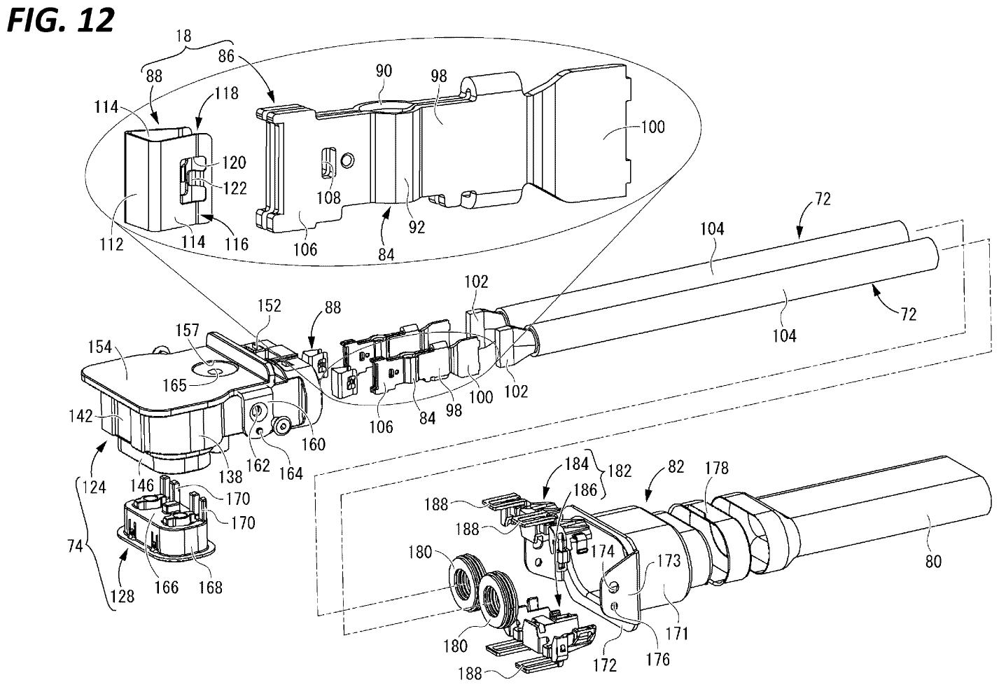

As also shown in FIGS. 3, 12 and the like, the second connector 14 is provided with the second terminal fittings 18 to be connected to ends of the coated wires 72 and connected to the first terminal fittings 16, a second connector housing 74, which is an insulating housing for accommodating the second terminal fittings 18, and a flat plate portion 76 made of metal and fixedly disposed on an upper surface side, which is an outer surface side, of the second connector housing 74. Further, the second connector 14 also includes a shield bracket 82 to be connected to a braided wire 80 serving as a shield member for covering the coated wires 72 extending from wire pull-out openings 78 provided in the second connector housing 74, thereby surrounding the wire pull-out openings 78. In this embodiment, a pair of the coated wires 72, 72 and a pair of the second terminal fittings 18, 18 are provided, the respective coated wires 72 and the respective second terminal fittings 18 are facing each other in the lateral direction.

### (Second Terminal Fitting 18)

A specific structure of the second terminal fitting 18 is not limited as long as the second terminal fitting 18 includes the tubular connecting portion 84, into which the columnar connecting portion 24 of the first terminal fitting 16 is press-fit. For example, the structure of a female terminal (10) described in Japanese Patent Laid-open Publication No. 2021-028899 can be adopted. More particularly, the second terminal fitting 18 of this embodiment includes a second terminal fitting body 86 and a clip spring 88 serving as a resilient member to be attached to a tip part (front end part) of the second terminal fitting body 86.

### (Second Terminal Fitting Body 86)

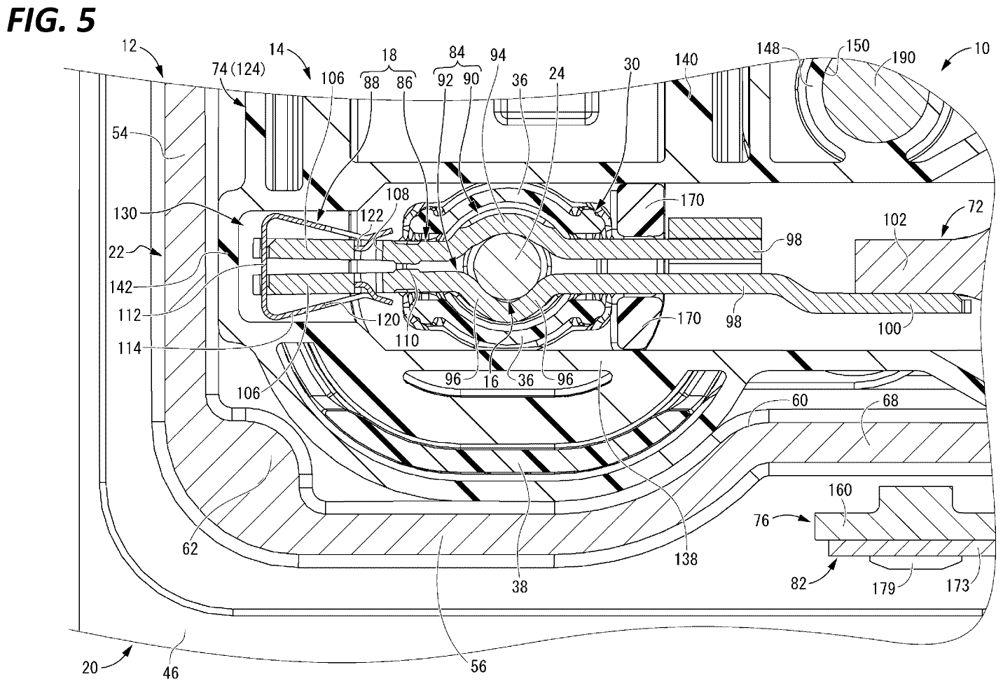

The second terminal fitting body 86 is formed, such as by press-working a metal flat plate having a substantially strip-like shape as a whole into a predetermined shape. The second terminal fitting body 86 includes the aforementioned tubular connecting portion 84 and, in this embodiment, the tubular connecting portion 84 having a substantially hollow cylindrical shape is open on both sides in the vertical direction. As also shown in FIGS. 4 and 5, this tubular connecting portion 84 is composed of a first peripheral wall portion 90 located on a left side and a second peripheral wall portion 92 located on a right side, each peripheral wall portion having a substantially half-cylindrical shape, and these first and second peripheral wall portions 90, 92 are facing each other in the lateral direction.

An arcuate protrusion 94 projecting radially inward in a circumferential central part while extending in a circumferential direction is provided on the inner peripheral surface of the first peripheral wall portion 90. Further, linear contact portions 96 projecting radially inward while extending in an axial direction (vertical direction) of the tubular connecting portion 84 are provided at a plurality of positions (two positions) separated in the circumferential direction. In this way, as also shown in FIG. 5, when the columnar connecting portion 24 is press-fit into the tubular connecting portion 84, the outer peripheral surface of the columnar connecting portion 24 and the inner peripheral surface of the tubular connecting portion 84 come into contact at three positions on a circumference at the circumferential central part of the arcuate protrusion 94 and a pair of the linear contact portions 96, 96.

Further, a pair of base end side plate portions 98, 98 extending rearward are provided on rear end parts of the first and second peripheral wall portions 90, 92, and are facing each other in the lateral direction. These base end side plate portions 98 are coupled to each other, such as by being bent in rear end parts thereof. Further, the second terminal fitting body 86 includes a part extending further rearward than the respective base end side plate portions 98, and this rearward extending part serves as a wire fixing portion 100, to which the coated wire 72 is fixed. That is, the coated wire 72 is composed of a core wire 102 and an insulation coating 104 made of synthetic resin and covering the core wire 102 substantially over an entire length. The insulation coating 104 is stripped at the end of the coated wire 72 to expose the core wire 102 and the exposed core wire 102 is fixed to the wire fixing portion 100 of the second terminal fitting body 86, whereby the second terminal fitting body 86 and the coated wire 72 are connected. Note that a method for fixing the wire fixing portion 100 and the core wire 102 is not limited, and the wire fixing portion 100 and the core wire 102 may be fixed by adhesion, welding, crimping using a crimping piece or the like.

Further, a pair of tip side plate portions 106, 106 respectively projecting forward are provided on front end parts of the first and second peripheral wall portions 90, 92, and are facing each other in the lateral direction. That is, in the second terminal fitting body 86, the respective base end side plate portions 98 are coupled to each other behind the first and second peripheral wall portions 90, 92, and the respective tip side plate portions 106 are cantilevered while being separated from each other and constitute free ends in front of the first and second peripheral wall portions 90, 92. In this way, the respective tip side plate portions 106 are resiliently deformable in directions toward or away from each other.

A substantially rectangular through hole 108 penetrating in a plate thickness direction (lateral direction) is formed in a central part in a width direction (vertical direction) in an intermediate part in the front-rear direction of each tip side plate portion 106. Further, a stopper portion 110 projecting laterally inward is provided in a widthwise central part on the laterally inner surface of each tip side plate portion 106. In this embodiment, each stopper portion 110 is provided behind the through hole 108. In this way, the respective stopper portions 110 contact each other when the clip spring 88 is attached to the tip part of the second terminal fitting body 86, whereby deformation amounts of the respective tip side plate portions 106 in the directions toward each other are limited and, consequently, the first and second peripheral wall portions 90, 92 connected behind the respective tip side plate portions 106 are prevented from coming too close to each other to excessively reduce an inner diameter of the tubular connecting portion 84.

### (Clip Spring 88)

The clip spring 88 biases the respective tip side plate portions 106 in the directions toward each other and applies biasing forces in the directions toward each other to the first and second peripheral wall portions 90, 92 connected behind the respective tip side plate portions 106 by being attached to the tip part of the second terminal fitting body 86. As shown in FIGS. 5 and 12, the clip spring 88 includes a coupling plate 112 having a substantially rectangular shape when viewed from the front-rear direction and a pair of pressing pieces 114, 114 projecting rearward from both lateral end parts of the coupling plate 112 and inclined to the directions toward each other. Bent parts 116 are provided in intermediate parts in the front-rear direction of the respective pressing pieces 114 and projecting tip parts of the respective pressing pieces 114 extend in directions separating from each other from the respective bent parts 116. Therefore, a facing distance of the respective pressing pieces 114 is shortest in a part where the respective bent parts 116 are formed, and a gap between these bent parts 116 serves as an insertion opening 118, through which the second terminal fitting body 86 is inserted into the clip spring 88.

A substantially rectangular through window 120 penetrating the pressing piece 114 in a plate thickness direction is formed in a central part in the width direction (vertical direction) in the bent part 116 of each pressing piece 114. A locking piece 122 projecting forward is provided in a widthwise center of a rear inner peripheral edge part of each through window 120. The respective locking pieces 122 are facing each other in the lateral direction and project more inward in the facing direction toward the front. These locking pieces 122 are resiliently deformable in the plate thickness direction, and the tip part of the second terminal fitting body 86 is inserted into the insertion opening 118 of the clip spring 88 when the clip spring 88 is attached to the second terminal fitting body 86 as described later. Then, by sliding the clip spring 88 rearward with respect to the second terminal fitting body 86, the respective locking pieces 122 enter and are locked in the through windows 108 in the respective tip side plate portions 106 and the clip spring 88 is fixed to the second terminal fitting body 86.

### (Second Connector Housing 74)

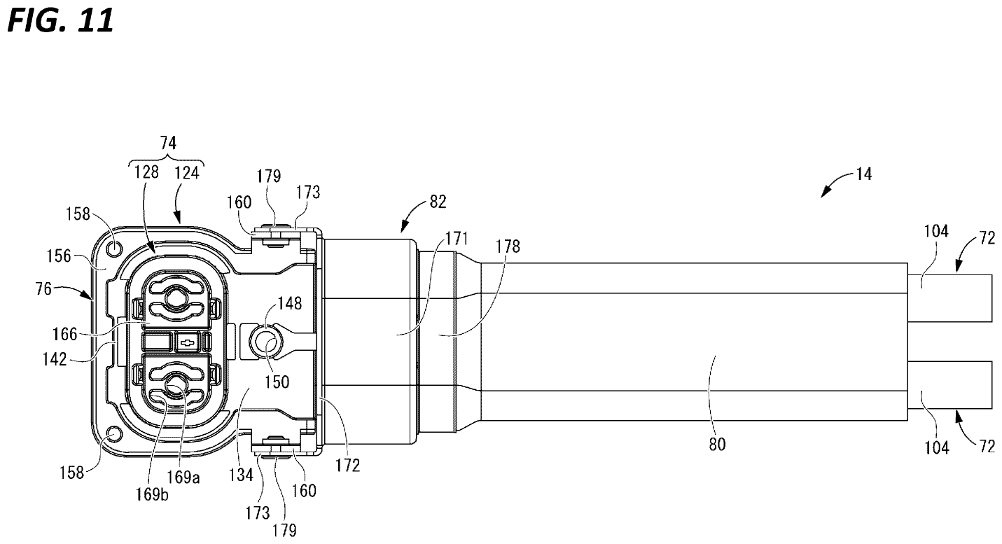

As also shown in FIGS. 11 and 12, the second connector housing 74 includes a second connector housing body 124 and a front retainer 128 to be mounted into a lower opening 126 of the second connector housing body 124.

As also shown in FIGS. 3, 6, 7 and the like, the second connector housing body 124 includes terminal accommodating portions 130 substantially in the form of rectangular tubes for accommodating front end parts of the respective coated wires 72 and the respective second terminal fittings 18 fixed to the ends of the respective coated wires 72. These terminal accommodating portions 130 extend in the front-rear direction and, in this embodiment, a pair of the terminal accommodating portions 130 are provided apart from each other in the lateral direction. That is, the second connector housing body 124 is provided with an upper wall portion 132 constituting wall portions on upper sides of the respective terminal accommodating portions 130, a lower wall portion 134 constituting wall portions on lower sides and a left wall portion 136 and a right wall portion 138 constituting laterally outer wall portions of the respective terminal accommodating portions 130. Further, the second connector housing body 124 is provided with a partitioning portion 140 partitioning the respective terminal accommodating portions 130 in the lateral direction by being provided between the respective terminal accommodating portions 130 in the lateral direction. The respective terminal accommodating portions 130 are closed from front by a front wall portion 142, and the respective coated wires 72 accommodated in the respective terminal accommodating portions 130 are pulled out to an outside space through rear openings of the respective terminal accommodating portions 130. Therefore, the wire pull-out openings 78, through which the respective coated wires 72 are pulled out, are constituted by the rear openings of the respective terminal accommodating portions 130 in the second connector housing 74.

Further, a front part of the lower wall portion 134 of the second connector housing body 124 is formed with a through hole 144 penetrating through the lower wall portion 134 in a thickness direction (vertical direction). This through hole 144 has a substantially elliptical shape with a dimension in the lateral direction larger than a dimension in the front-rear direction, and provided over the respective terminal accommodating portions 130 separated from each other in the lateral direction. That is, the respective terminal accommodating portions 130 communicate with the outside space below through the common through hole 144. A tubular portion 146 projecting downward is provided on a peripheral edge part of this through hole 144, and the lower opening 126 in the second connector housing body 124 is constituted by a lower end part of the tubular portion 146. As described later, the tubular connecting portions 84 of the respective second terminal fittings 18 accommodated in the respective terminal accommodating portions 130 are exposed to outside through the lower opening 126 in the second connector housing body 124.

Note that, in the partitioning portion 140 located between the respective terminal accommodating portions 130 in the lateral direction, a bolt insertion tube portion 148, into which the fastening bolt 190 to be described later is inserted, is provided behind the tubular portion 146, and an inner hole 150 of the bolt insertion tube portion 148 penetrates through the second connector housing body 124 in the vertical direction. That is, the bolt insertion tube portion 148 and the fastening bolt 190 to be described later extend in the vertical direction, which is a projecting direction of the receptacle 22. Further, in the second connector housing body 124, lock claw portions 152 projecting vertically outward are provided on rear end parts of the upper and lower wall portions 132, 134. These lock claw portions 152 are provided at positions corresponding to the respective terminal accommodating portions 130, and a pair of lock claw portions 152, 152 are provided apart from each other in the lateral direction on the rear end part of each of the upper and lower wall portions 132, 134.

### (Flat Plate Portion 76)

Here, the second connector housing body 124 is formed as a composite member of synthetic resin and metal, and the flat plate portion 76 made of metal is fixedly disposed on the upper wall portion 132 on an outer surface side in the second connector housing body 124. Specifically, the flat plate portion 76 is fixed to the upper surface of the upper wall portion 132. The flat plate portion 76 has a substantially rectangular shape in a plan view, has a lateral dimension to project further laterally outward than the left and right wall portions 136, 138 and project further forward than the front wall portion 142 in a plan view projection. Note that a rear end part of the flat plate portion 76 is bent upward to constitute an upward projecting portion 153.

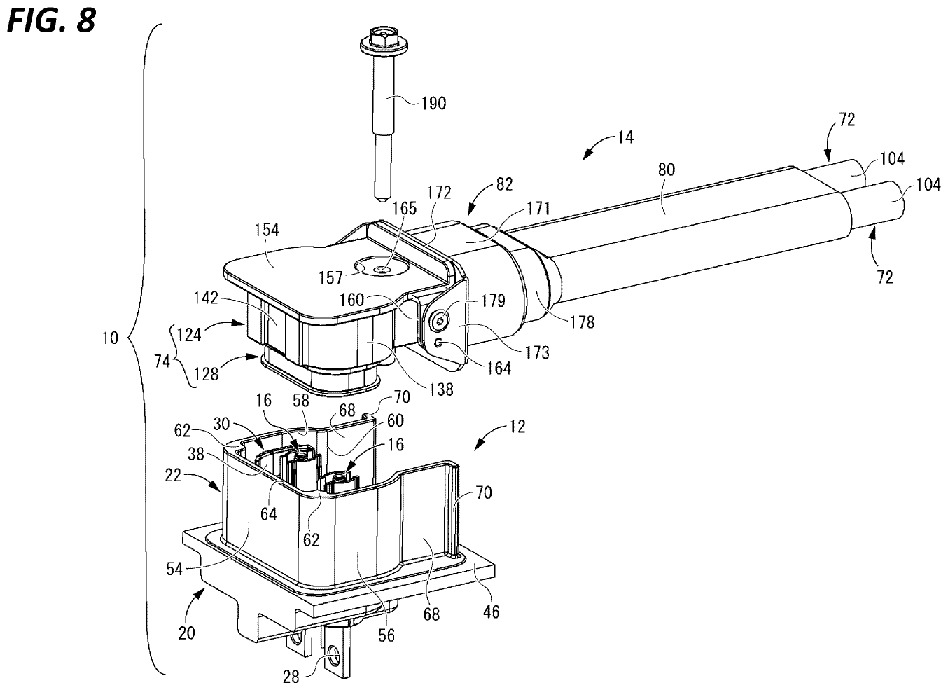

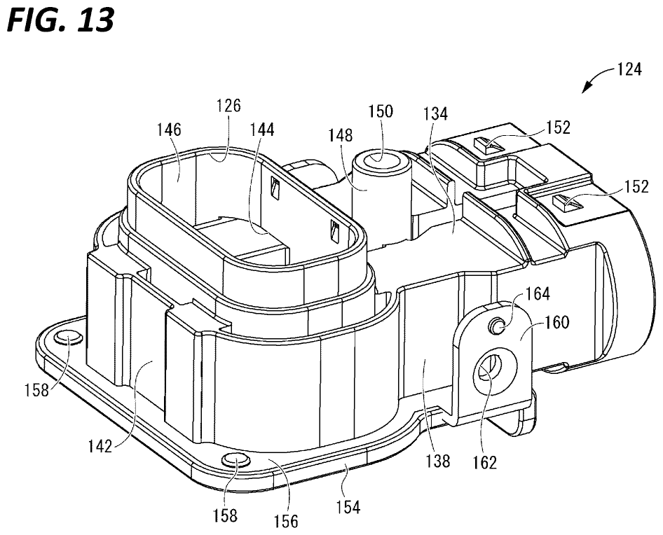

An upper part and an outer peripheral part of the flat plate portion 76 are substantially entirely covered by an outer covering portion 154 made of synthetic resin. Note that, if the upper wall portion 132 is seen to include the outer covering portion 154, the flat plate portion 76 is grasped to be fixed in a substantially embedded state in the upper wall portion 132. In this way, as also shown in FIG. 13, the lower surface of the flat plate portion 76 is exposed to outside on lateral outer sides of the left and right wall portions 136, 138 and in front of the front wall portion 142. This outward exposed part of the lower surface of the flat plate portion 76 serves as a contact portion 156 for contacting the upper end surface 64, which is the projecting end surface of the receptacle 22 of the first connector 12, as described later. Note that, as also shown in FIG. 8, a circular through window 157 is formed at the formation position of the bolt insertion tube portion 148 in the outer covering portion 154, and the upper surface of the flat plate portion 76 is exposed to the outside space through the through window 157.

In this embodiment, contact point portions 158 projecting downward are integrally formed to the flat plate portion 76 on both left and right end parts of the front part of the contact portion 156. That is, each of these contact point portions 158 projects from the contact portion 156 toward the upper end surface 64 in the vertical direction, which is an overlapping direction of the contact portion 156 and the upper end surface 64. More particularly, in the contact portion 156, two contact point portions 158, 158 are provided at positions corresponding to both left and right end parts of a facing wall (front wall portion 54) facing the lateral opening (rear opening 60) of the receptacle 22 in the front-rear direction. In short, the respective contact point portions 158 are distributed and arranged on both sides across the fastening bolt 190 to be described later in a direction (lateral direction) orthogonal to a facing direction of the lateral opening (rear opening 60) and the facing wall (front wall portion 54). Specifically, the respective contact point portions 158 are provided at positions corresponding to parts having a large width of the upper end surface 64 by providing the respective thick portions 62 in the receptacle 22, so that the respective contact point portions 158 and the upper end surface 64 more reliably contact each other.

Further, a pair of fastening pieces 160, 160 projecting downward toward the receptacle 22 are provided on both left and right end parts in a rear end part of the flat plate portion 76. The respective fastening pieces 160 are located laterally outward of the left and right wall portions 136, 138 in the second connector housing body 124 while being separated by a predetermined separation distance. Specifically, the respective fastening pieces 160 are located laterally outward of the respective guide wall portions 68 in the receptacle 22 when the first and second connectors 12, 14 are connected, and located laterally inward of intermediate parts in the front-rear direction of the respective side wall portions 56 (outermost parts of the receptacle 22) located most laterally outward in the receptacle 22.

Further, each fastening piece 160 has a predetermined vertical dimension, a bolt fastening hole 162 penetrating through the fastening piece 160 in a thickness direction (lateral direction) is formed in an upper part of each fastening piece 160, and a locking protrusion 164 projecting laterally outward is provided on a lower part of each fastening piece 160. Note that a communication hole 165 penetrating in the vertical direction is formed at a position corresponding to the inner hole 150 of the bolt insertion tube portion 148 in the flat plate portion 76.

As also shown in FIGS. 3, 12 and the like, the front retainer 128 has a substantially bottomed tube shape and includes a substantially elliptical upper bottom wall portion 166 and a peripheral wall portion 168 projecting downward from an outer peripheral edge part of the upper bottom wall portion 166. Through holes 169a, through which the respective columnar connecting portions 24 are inserted, are formed to penetrate in the vertical direction at positions corresponding to the respective columnar connecting portions 24 in the first connector housing 30, and through holes 169b, through which the respective curved plate portions 36 are inserted, are formed to penetrate in the vertical direction at positions corresponding to the respective curved plate portions 36 located on both lateral sides of the respective columnar connecting portions 24. In this way, when the first and second connectors 12, 14 are connected, the respective columnar connecting portions 24 and the respective curved plate portions 36 are inserted into the respective terminal accommodating portions 130 in the second connector housing 74 through the respective through holes 169a, 169b in the upper bottom wall portion 166.

This front retainer 128 is inserted into the tubular portion 146 in the second connector housing body 124 and fixed by a locking mechanism provided on the outer peripheral surface of the peripheral wall portion 168 and the inner peripheral surface of the tubular portion 146. Note that a pair of supporting protrusions 170, 170 projecting upward and separated from each other in the lateral direction are provided on both left and right sides in a rear end part of the upper bottom wall portion 166. As shown in FIG. 5, the respective base end side plate portions 98 in each second terminal fitting body 86 are inserted and supported between the pair of supporting protrusions 170, 170 in the lateral direction when the second connector 14 is assembled.

The respective coated wires 72 pulled out rearward from the respective wire pull-out openings 78 of the second connector housing 74 as described above are covered by the braided wire 80 serving as the shield member. The braided wire 80 is formed by braiding thin metal wires into a substantially tube shape and covers the respective coated wires 72 pulled out from the respective wire pull-out openings 78 over a predetermined dimension in the front-rear direction.

The shield bracket 82 is connected to a front end part of the braided wire 80. The shield bracket 82 includes a tubular wall portion 171 extending in the front-rear direction as a whole and is made of electrically conductive metal. A substantially annular flange-like portion 172 projecting toward an outer peripheral side is provided on a front end part of the shield bracket 82 (tubular wall portion 171), and fixing pieces 173 projecting forward are provided on both lateral end parts of the flange-like portion 172. A bolt insertion hole 174 is provided in an upper part of each fixing piece 173, and a locking hole 176 penetrating in the thickness direction (lateral direction) is formed in a lower part of each fixing piece 173.

Further, as described later, the respective fixing pieces 173 in the shield bracket 82 are overlapped on the respective fastening pieces 160 in the second connector housing 74 in the lateral direction and fixed by bolts 179 inserted into the respective bolt insertion holes 174 when the second connector 14 is assembled. In this way, the respective fastening pieces 160 in the flat plate portion 76 and the respective fixing pieces 173 in the shield bracket 82, all being made of metal, contact each other and are electrically connected.

Note that any further forward displacement of the shield bracket 82 with respect to the second connector housing body 124 is limited by the mutual contact of the upper projecting portion 153 projecting upward from the flat plate portion 76 and the flange-like portion 172 provided on the front end part of the tubular wall portion 171 when the second connector 14 is assembled as described later. Further, the respective fastening pieces 160 and the flange-like portion 172 are facing each other in the front-rear direction while being separated by a predetermined distance when the second connector 14 is assembled. When the connector assembly 10 is assembled, the respective bent portions 70 in the rear end part of the receptacle 22 are located between the respective fastening pieces 160 and the flange-like portion 172 in the front-rear direction as shown in FIG. 2. In this way, position shifts of the first and second connectors 12, 14 in the front-rear direction in the connector assembly 10 can be effectively prevented.

The respective coated wires 72 are inserted into the tubular wall portion 171 of such a shield bracket 82, the front end part of the substantially tubular braided wire 80 is overlapped on a rear end part of the tubular wall portion 171 and an annular crimp band 178 is externally fit from an outer peripheral side, whereby shield bracket 82 and the braided wire 80 are fixed and electrically connected to each other.

With the respective coated wires 72 inserted through the shield bracket 82, annular waterproof rubbers 180 and a back retainer 182 for preventing the detachment of the waterproof rubbers 180 are provided inside the tubular wall portion 171. That is, the annular waterproof rubber 180 is externally fit and mounted on each coated wire 72 and inserted into the rear opening in the second connector housing 74.

Further, the back retainer 182 is composed of an upper retainer 184 and a lower retainer 186, which can be assembled with each other, and the upper and lower retainers 184, 186 are assembled to sandwich the respective coated wires 72 from both sides in the vertical direction behind the second connector housing 74. Each of these upper and lower retainers 184, 186 includes a pair of lock frame bodies 188, 188 projecting forward. In this way, the back retainer 182 configured by assembling the upper and lower retainers 184, 186 is fixed behind the respective waterproof rubbers 180 by fitting and locking the respective lock claw portions 152 provided in a rear end part of the second connector housing 74 and the respective lock frame bodies 188. Note that the upper and lower retainers 184, 186 may have the same shape and the back retainer 182 may be configured by assembling the upper and lower retainers 184, 186 in a vertically inverted state with each other.

### (Assembly of Connector Assembly 10)

Hereinafter, a specific example of a method for assembling the connector assembly 10 by connecting the first and second connectors 12, 14 is described. Note that the assembly method of the connector assembly 10 is not limited to the one described below.

First, the first connector housing 30 is formed as an integrally molded product provided with the respective first terminal fittings 16, and the waterproof rubber 45 is mounted on the outer peripheral surface of this first connector housing 30. A lower part of the first connector housing 30 having the waterproof rubber 45 mounted thereon is inserted into the insertion hole 48 in the casing 20, and the respective bolt insertion holes 42 in the first connector housing 30 and the respective bolt fastening holes 52 in the casing 20 are caused to communicate with each other. By inserting the respective bolts 44 into these bolt insertion holes 42 and fastening the bolts 44 to the bolt fastening holes 52, the first connector housing 30 is fixed to the housing 20 and the first connector 12 is completed.

Further, the core wire 102 exposed by stripping the insulation coating 104 at the end of each coated wire 72 is fixed to the wire fixing portion 100 of each second terminal fitting body 86, and the clip spring 88 is attached to the front end part of each second terminal fitting body 86. In this way, the second terminal fitting 18 is fixed to the end of each coated wire 72. The waterproof rubber 180 is externally fit on each coated wire 72, and the upper and lower retainers 184, 186 are assembled from the both sides in the vertical direction to sandwich each coated wire 72 behind the waterproof rubber 180, thereby configuring the back retainer 182.

Subsequently, each coated wire 72 assembled with the second terminal fitting 18, the waterproof rubber 180 and the back retainer 182 is inserted through the rear opening of the second connector housing body 124. Then, each second terminal fitting 18 is accommodated into each terminal accommodating portion 130 of the second connector housing body 124, and the respective lock frame bodies 188 in the back retainer 182 are fit and locked to the respective lock claw portions 152 in the rear end part of the second connector housing body 124. Thereafter, each coated wire 72 is inserted through the tubular wall portion 171 of the shield bracket 82, the shield bracket 82 is moved forward, and the respective fixing pieces 173 of the shield bracket 82 are overlapped on the respective fastening pieces 160 in the second connector housing body 124 from outside in the lateral direction. In this way, the locking protrusion 164 in each fastening piece 160 enters the locking hole 176 in each fastening piece 173, and each bolt fastening hole 162 and each bolt insertion hole 174 are caused to communicate in the lateral direction. By inserting the bolt 179 into each bolt insertion hole 174 and fastening the bolt 179 to each bolt fastening hole 162, the shield bracket 82 is fixed to the second connector housing body 124.

Subsequently, each coated wire 72 is inserted into the braided wire 80 behind the shield bracket 82 and the front end part of the braided wire 80 is externally fit and overlapped on the rear end part of the tubular wall portion 171. Then, the crimp band 178 is externally fit to the overlapping part of these shield bracket 82 and braided wire 80 to fix the shield bracket 82 and the braided wire 80. Thereafter, the front retainer 128 is inserted through the lower opening 126 of the second connector housing body 124 and fixed to the tubular portion 146. In this way, the second connector housing 74 is configured and the second connector 14 is completed. In the completed second connector 14, the braided wire 80, the shield bracket 82 and the flat plate portion 76 are electrically connected.

The completed first and second connectors 12, 14 are caused to face each other in the vertical direction as shown in FIG. 8. Thereafter, the second connector housing 74 is inserted into the receptacle 22 of the first connector 12 through the upper opening 58. In this way, the left wall portion 136, the right wall portion 138 and the front wall portion 142 of the second connector housing 74 are accommodated in a region surrounded by the receptacle 22, and a rear part of the second connector housing 74 extends rearward through the rear opening 60 in the receptacle 22. Further, the respective fastening pieces 160 and the respective fixing pieces 173 overlapped and fixed to each other are located laterally outward of the respective guide wall portions 68 in the receptacle 22. In other words, the respective guide wall portions 68 in the receptacle 22 are inserted between the left and right wall portions 136, 138 and the respective fastening pieces 160 in the lateral direction. Further, the respective bent portions 70 provided on the rear end parts of the respective guide wall portions 68 are inserted between the respective fastening pieces 160 and the flange-like portion 172 in the shield bracket 82. As a result, the rear opening 60 in the receptacle 22, i.e. a rearward opening constituted by the rear end parts of the respective guide wall portions 68, is covered by the shield bracket 82.

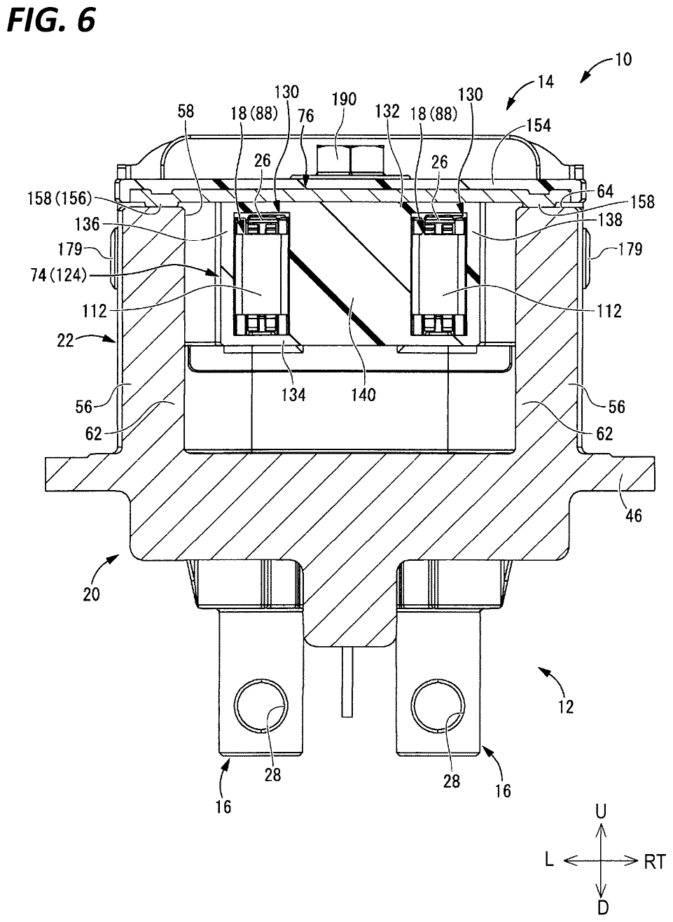

Further, the lower surface (contact portion 156) of the flat plate portion 76 extending laterally outward of the left and right wall portions 136, 138 and extending further forward than the front wall portion 142 in the second connector housing 74 are overlapped on the upper end surface 64 of the receptacle 22 in the vertical direction. In short, the contact portion 156 in the flat plate portion 76 is placed on and connected to the upper end surface 64 of the receptacle 22. As a result, the upper opening 58 of the receptacle 22 is covered by the flat plate portion 76. Particularly, as shown in FIG. 6, parts provided with respective thick portions 62 and having an increased width of the upper end surface 64 are overlapped on the contact point portions 158 projecting downward on the flat plate portion 76. In this way, the front part of the second connector housing 74 is resiliently deformed to be slightly deflected upward. A contact pressure between the contact point portions 158 and the upper end surface 64 is sufficiently ensured by a restoring force associated with this resilient deformation. The flat plate portion 76 and the casing 20 are electrically connected by the contact of these contact portion 156 and upper end surface 64, particularly by the contact of the contact point portions 158 and the upper end surface 64 at the respective thick portions 62. This casing 20 is grounded, whereby a shielding effect is exhibited in the braided wire 80 electrically connected to the casing 20 by way of the flat plate portion 76 and the shield bracket 82.

Furthermore, by inserting the second connector housing 74 into the receptacle 22 in this way, the columnar connecting portions 24 of the respective first terminal fittings 16 projecting upward in the receptacle 22 are press-fit into the tubular connecting portions 84 of the second terminal fittings 18 exposed downward through the lower opening 126 and the through hole 144 in the second connector 14. In this way, as described above, the inner peripheral surface of the tubular connecting portion 84 contacts the outer peripheral surface of the columnar connecting portion 24 at three positions (the circumferential central part of the arcuate protrusion 94 and the pair of linear contact portions 96, 96) on the circumference, whereby each first terminal fitting 16 and each second terminal fitting 18 are brought into an electrically conductive state.

In such a connected state of the first and second connectors 12, 14, the fastening bolt 190 is inserted into the bolt insertion tube portion 148 in the second connector 14 and fastened to the bolt fastening hole 50 in the first connector 12. In this way, the first and second connectors 12, 14 are fixed to each other and the connector assembly 10 is completed. Particularly, the outer covering portion 154 in the second connector 14 is formed with the through window 157, and the flat plate portion 76 is exposed to outside through the through window 157. As a result, when the fastening bolt 190 is fastened, a head part of the fastening bolt 190 and the flat plate portion 76 are electrically connected and the fastening bolt 190 and the casing 20 in the first connector 12 are electrically connected. In short, the flat plate portion 76 and the casing 20 are electrically connected also via the fastening bolt 190.

In the connector assembly 10 of this embodiment structured as described above, the front part of the second connector housing 74, i.e. a part accommodating the respective second terminal fittings 18 in the second connector housing 74, is accommodated and arranged in the receptacle 22 in the connected state of the first and second connectors 12, 14. Further, the contact portion 156 of the flat plate portion 76 is placed on and connected to the upper end surface 64 of the receptacle 22, and the upper opening 58 of the receptacle 22 is covered by the flat plate portion 76. These receptacle 22 and flat plate portion 76 are both made of metal and the respective first terminal fittings 16 and the respective second terminal fittings 18, which are electrically connected parts of the first and second connectors 12, 14, are surrounded by a member made of metal. In this way, a shielding effect can be obtained by the simply structured receptacle 22 and flat plate portion 76, which can be formed, for example, by press working, without providing a large-size shield shell in the second connector 14. As a result, the structure simplification, manufacturing cost reduction and miniaturization of the connector assembly 10 can be achieved.

The second connector 14 is provided with the braided wire 80 serving as the shield member for covering the respective coated wires 72 and the shield bracket 82 to be connected to the braided wire 80, and these braided wire 80 and shield bracket 82 are grounded via the flat plate portion 76 and the casing 20. In this way, a shielding effect can be exhibited also in the braided wire 80 covering the respective coated wires 72.

The contact point portion 158 projecting toward the upper end surface 64 of the receptacle 22 is provided on the contact portion 156 of the flat plate portion 76, and a contact pressure between the contact portion 156 and the upper end surface 64 is improved at this contact point portion 158. In this embodiment, the pair of contact point portions 158, 158 are provided on the both lateral sides of the contact portion 156, the flat plate portion 76 and the casing 20 are electrically connected at these contact point portions 158 and the flat plate portion 76 and the casing 20 are electrically connected also by the fastening bolt 190 in the lateral central part of the second connector 14. By providing the respective contact point portions 158 at bilaterally symmetrical positions with respect to the fastening bolt 190 in this way, the second connector 14 is prevented from being inclined with respect to the first connector 12 and the contact stability of the contact portion 156, particularly the respective contact point portions 158, of the flat plate portion 76 and the upper end surface 64 is ensured.

The respective guide wall portions 68 extending rearward in the receptacle 22 are located laterally inward of the respective side wall portions 56, and the respective fastening pieces 160 and the respective fixing pieces 173 are arranged in these regions recessed inward when the first and second connectors 12, 14 are connected. In this way, even if the flat plate portion 76 and the shield bracket 82 are connected on the both lateral sides, laterally outward projecting amounts can be suppressed and the connector assembly 10 can be reduced in size in the lateral direction.

The bent portion 70 bent laterally outward is provided on the rear end part of each guide wall portion 68, whereby a reinforcing effect of each guide wall portion 68 can be exhibited. Particularly, when the first and second connectors 12, 14 are connected, each bent portion 70 is arranged between the fastening piece 160 and the flange-like portion 172 in the shield bracket 82 in the front-rear direction. In this way, even if an external force is, for example, applied in the front-rear direction to the second connector 14 at the time of connection to the first connector 12, the respective bent portions 70 contact the respective fastening pieces 160 and the flange-like portion 172, whereby a displacement of the second connector 14 with respect to the first connector 12 in the front-rear direction can be suppressed.

### <Modifications>

Although the embodiment has been described in detail as a specific example of the present disclosure above, the present disclosure is not limited by this specific description. Modifications, improvements and the like within a range in which the aim of the present disclosure can be achieved are included in the present disclosure. For example, the following modifications of the embodiment are also included in the technical scope of the present disclosure.

(1) The shapes of the first and second terminal fittings 16, 18 in the above embodiment are merely illustrative, but not restrictive. That is, although the first terminal fitting 16 includes the pin-shaped columnar connecting portion 24 and the second terminal fitting 18 includes the tubular connecting portion 84 in the above embodiment, there is no limitation to this mode. A first terminal fitting may be in the form of a flat tab as described, for example, in International Publication No. WO 2021/145197 and, in that case, a second terminal fitting may include a substantially rectangular terminal insertion gap.

(2) Although the respective contact point portions 158 projecting toward the upper end surface 64 of the receptacle 22 are provided on the lower surface (contact portion 156) of the flat plate portion 76 in the above embodiment, there is no limitation to this mode. That is, contact point portions may be provided to project toward a contact portion from the upper end surface of a receptacle or may be provided on both the contact portion and the upper end surface of the receptacle. Further, although the respective contact point portions 158 are provided on the both lateral end parts of the front end part of the contact portion 156 in the above embodiment, the formation positions and number of contact point portions are not limited and one, three or more contact point portions may be provided. Note that, in the connector assembly according to the present disclosure, the contact point portions are not essential.

(3) Although the respective fastening pieces 160 projecting laterally outward from the flat plate portion 76 are provided and the flat plate portion 76 and the shield bracket 82 are connected on both lateral sides in the above embodiment, there is no limitation to this mode. That is, for example, a part extending forward from an upper part of a shield bracket may be provided, and a flat plate portion and the shield bracket may be connected at upper parts thereof.

(4) Although the respective guide wall portions 68 are located laterally inward of the intermediate parts in the front-rear direction of the respective side wall portions 56 in the receptacle 22 in the above embodiment, there is no limitation to this mode. That is, guide wall portions are not essential in the connector assembly according to the present disclosure and side wall portions in a receptacle may extend straight rearward.

(5) Although the receptacle 22 and the casing 20 are integrally formed in the above embodiment, there is no limitation to this mode. That is, a casing and a receptacle, both being made of metal, may be separately formed and fixed later by welding or other means.

### LIST OF REFERENCE NUMERALS

10 connector assembly
12 first connector
14 second connector
16 first terminal fitting
18 second terminal fitting
20 casing
22 receptacle
24 columnar connecting portion
26 resin cap
28 bolt insertion hole
30 first connector housing
32 through hole
34 peripheral wall portion
36 curved plate portion
38 outer wall portion
40 leg portion
42 bolt insertion hole
44 bolt
45 waterproof rubber
46 rectangular plate portion
48 insertion hole
50, 52 bolt fastening hole
54 front wall portion
56 side wall portion
58 upper opening (projecting side opening)
60 rear opening (lateral opening)
62 thick portion
64 upper end surface (projecting end surface)
66 rear end surface (peripheral wall end surface)
68 guide wall portion
70 bent portion
72 coated wire
74 second connector housing (housing)
76 flat plate portion
78 wire pull-out opening
80 braided wire (shield member)
82 shield bracket
84 tubular connecting portion
86 second terminal fitting body
88 clip spring
90 first peripheral wall portion
92 second peripheral wall portion
94 arcuate protrusion
96 linear contact portion
98 base end side plate portion
100 wire fixing portion
102 core wire
104 insulation coating
106 tip side plate portion
108 through hole
110 stopper portion
112 coupling plate
114 pressing piece
116 bent part
118 insertion opening
120 through window
122 locking piece
124 second connector housing body
126 lower opening
128 front retainer
130 terminal accommodating portion
132 upper wall portion
134 lower wall portion
136 left wall portion
138 right wall portion
140 partitioning portion
142 front wall portion
144 through hole
146 tubular portion
148 bolt insertion tube portion
150 inner hole
152 lock claw portion
153 upper projecting portion
154 outer covering portion
156 contact portion
157 through window
158 contact point portion
160 fastening piece
162 bolt fastening hole
164 locking protrusion
165 communication hole
166 upper bottom wall portion
168 peripheral wall portion
169a, 169b through hole
170 supporting protrusion
171 tubular wall portion
172 flange-like portion
173 fixing piece
174 bolt insertion hole
176 locking hole
178 crimp band
179 bolt
180 waterproof rubber
182 back retainer
184 upper retainer
186 lower retainer
188 lock frame body
190 fastening bolt

1. A connector assembly, comprising:
a first connector; and
a second connector to be connected to the first connector,
the first connector including a first terminal fitting projecting outward from a casing made of metal and a receptacle made of metal and projecting outward from the casing while surrounding the first terminal fitting,
the second connector including a second terminal fitting to be connected to an end of a coated wire and connected to the first terminal fitting, an insulating housing for accommodating the second terminal fitting and a flat plate portion made of metal and fixedly disposed on an outer surface side of the housing, and
in a connected state of the first and second connectors, the housing of the second connector being accommodated and arranged in the receptacle of the first connector, a contact portion of the flat plate portion being placed on and connected to a projecting end surface of the receptacle and a projecting side opening of the receptacle being covered by the flat plate portion.

2. The connector assembly of claim 1, wherein:
the second connector further includes a shield bracket to be connected to a shield member for covering the coated wire extending from a wire pull-out opening provided in the housing, thereby surrounding the wire pull-out opening,
the shield bracket is assembled with and connected to the flat plate portion,
the receptacle of the first connector includes a lateral opening, the coated wire being pulled out through the lateral opening, and
the lateral opening of the receptacle is covered by the shield bracket in the connected state of the first and second connectors.

3. The connector assembly of claim 1, wherein at least one of the contact portion of the flat plate portion and the projecting end surface of the receptacle is provided with a contact point portion projecting toward the other in an overlapping direction of the flat plate portion on the projecting end surface.

4. The connector assembly of claim 3, wherein:
the first and second connectors are fastened to each other by a fastening bolt extending in a projecting direction of the receptacle,
the fastening bolt is arranged on the lateral opening side of the receptacle, and
a plurality of the contact point portions are distributed and arranged on both sides across the fastening bolt in a direction orthogonal to a facing direction of the lateral opening of the receptacle and a facing wall facing the lateral opening on the contact portion on the facing wall side.

5. The connector assembly of claim 2, wherein:
the receptacle includes a pair of guide wall portions respectively extending in a pull-out direction of the coated wire from a pair of peripheral wall end surfaces defining the lateral opening,
the flat plate portion includes a pair of fastening pieces projecting toward the receptacle, the shield bracket being bolted to the pair of fastening pieces, and
the pair of the fastening pieces are respectively arranged on outer sides in a facing direction of the guide wall portions across the pair of guide wall portions, and arranged inwardly of outermost parts of the receptacle in the facing direction of the guide wall portions.

6. The connector assembly of claim 5, wherein bent portions respectively bent outward in the facing direction of the guide wall portions are provided on end parts in an extension direction of the pair of guide wall portions.

7. A first connector to be used in the connector assembly of claim 1, the first connector being connected to the second connector.

8. A second connector to be used in the connector assembly of claim 1, the second connector being connected to the first connector.
